(19) United States
(12) Patent Application Publication
(10) Pub. No.: US 2026/0348387 A1
(43) Pub. Date: Nov. 5, 2026

(54) MOBILE PUMPING PACKAGE

(71) Applicant: Jeremy Leonard, Ardrossan (CA)

(72) Inventors: Jeremy Leonard, Ardrossan (CA); Caleb Dyck, Fort Saskatchewan (CA)

(21) Appl. No.: 19/633,876

(22) Filed: Mar. 30, 2026

(30) Foreign Application Priority Data
Apr. 30, 2025 (CA) 3272433

(51) Int. Cl. F04D 9/04; B62D 25/18; B62D 63/08; F04B 43/02; F04D 9/02; F04D 13/02; F04D 13/12

(52) U.S. Cl. CPC F04D 9/046; B62D 25/18; B62D 63/08; F04B 43/02; F04D 9/02; F04D 13/02; F04D 13/12

(57) ABSTRACT

A self-priming fluid pump has a diaphragm pump with a fluid intake and a fluid discharge. A vacuum chamber is elevated relative to the fluid intake, the vacuum chamber having a chamber inlet that is in fluid communication with the fluid intake, and a vacuum port. A vacuum pump is configured to apply vacuum pressure to the vacuum chamber via the vacuum port such that fluid is drawn into the vacuum chamber via the chamber inlet. A fluid level sensor is in the vacuum chamber. A controller is configured to activate and deactivate the diaphragm pump based on a fluid level sensed by the fluid level sensor.

### TECHNICAL FIELD

This relates to a pumping package, and in particular, a mobile pumping package with a driver and a fluid pump.

### BACKGROUND

Mobile pumping packages are often used to move fluid in industrial applications, typically to address a temporary or intermittent need. Mobile pumping packages may be used to either move liquid from, or supply liquid to, a location. A mobile pumping package is generally designed to be self-contained, and includes a driver, such as an internal combustion engine, that drives the fluid pump. To increase the range of applications, the fluid pump will often be a fluid pump that can handle solids, such as a suitably designed centrifugal pump. Examples of mobile pumping packages are offered by Canada Pump and Power Corp. under the trademark “Mighty Pumps” (mightypumps.com).

### SUMMARY

According to an aspect, there is provided a self-priming fluid pump, comprising a primary pump having a fluid intake and a fluid discharge. A vacuum chamber is elevated relative to the fluid intake, the vacuum chamber having a chamber inlet that is in fluid communication with the fluid intake, and a vacuum port. A vacuum pump is configured to apply vacuum pressure to the vacuum chamber via the vacuum port such that fluid is drawn into the vacuum chamber via the chamber inlet. A fluid level sensor is provided in the vacuum chamber. A controller is configured to activate and deactivate the vacuum pump based on a fluid level sensed by the fluid level sensor.

According to other aspects, the self-priming fluid pump may include one or more of the following features, alone or in combination: the primary pump may be a centrifugal pump; the vacuum pump may be a diaphragm pump; the fluid level sensor may be a float switch that senses when the fluid level is at or above a predetermined level; the controller may be configured to activate the vacuum pump when the fluid level is below a minimum fluid level within the vacuum chamber and deactivate the vacuum pump when the fluid level is below the minimum fluid level; the minimum fluid level may be at or above a maximum fluid height of the fluid discharge; the vacuum pump may be connected to the pump driver by a clutch, and the controller is configured to activate and deactivate the diaphragm pump by engaging and disengaging the clutch; the vacuum pump may be in communication with an air-filled portion of the vacuum chamber via the vacuum port, such that the vacuum pump is configured to apply a negative gas pressure to the vacuum chamber.

According to an aspect, there is provided a method of priming a pump, comprising the steps of:
providing: a primary pump having a fluid intake and a fluid discharge, a vacuum chamber that is elevated relative to the fluid intake and that has a vacuum port and a chamber inlet that is in fluid communication with the fluid intake; a vacuum pump that is connected to apply vacuum pressure to the vacuum chamber via the vacuum port, and a fluid level sensor in the vacuum chamber;
in response to a start signal to activate the vacuum pump, activating the vacuum pump to draw liquid into the vacuum chamber; and
deactivating the vacuum pump after the fluid level sensor senses a predetermined fluid level in the vacuum chamber.

According to other aspects, the method may comprises one or more of the following aspects, alone or in combination: the primary pump may be a centrifugal pump; the vacuum pump may be a diaphragm pump; the vacuum pump may be deactivated when the fluid level sensor senses a predetermined fluid level in the vacuum chamber; the vacuum pump may be permitted to activate if a temperature sensed by a temperature sensor is above a minimum temperature; the vacuum pump may be deactivated when the fluid level is above the minimum fluid level; the minimum fluid level may be at or above a maximum fluid height of the fluid discharge; the vacuum pump may be connected to the pump driver by a clutch, and activating the vacuum pump comprises engaging the clutch; the vacuum pump may be in communication with an air-filled portion of the vacuum chamber via the vacuum port, such that the vacuum pump applies a negative gas pressure to the vacuum chamber.

According to an aspect, there is provided a pumping package, comprising a driver, a fluid pump powered by the driver, and a chassis that supports the driver and the fluid pump, the chassis having an outer perimeter and a hitch connection at a towing end of the chassis. A set of wheels positioned outside the outer perimeter of the chassis, the set of wheels comprising first and second wheels on opposite sides of the chassis and mounted to rotate about an axis of rotation. Forklift channels are mounted to the chassis and adapted to permit the chassis to be lifted by a forklift, the forklift channels extending parallel to the axis of rotation, the forklift channels having a first end defining a tine receiver that extends past the outer perimeter of the chassis such that the tine receiver is at least conterminous with an outer surface of the first wheel.

According to other aspects, the pumping package may include one or more of the following features, alone or in combination: fenders may be mounted to the chassis, the fenders covering the first and second wheels and having an outer surface that is substantially conterminous with the outer surfaces of the first and second wheels; there may be a second set of wheels adjacent to the set of wheels; the forklift channels may be disposed on opposite sides of the axis of rotation; the forklift channels may have a second end opposite the first end that is conterminous with the outer surface of the second wheel; a portion of at least one of the forklift channels that extends past the outer perimeter may have a step surface.

According to an aspect, there is provided a pumping package, comprising a chassis, and a housing supported by the chassis, the housing comprising sidewalls and a roof panel supported by the sidewalls that define a housing enclosure, the roof panel comprising one or more roof vents that permit airflow between the housing enclosure and an external environment. A driver and a fluid pump are disposed within the housing enclosure. A drainage system is carried by the chassis, the drainage system comprising one or more collection trays at or adjacent to a top end of the housing and below the one or more roof vents, the one or more collection trays being disposed to capture fluid passing through the roof vents, and one or more drain lines that drain liquid from the collection trays, one or more drain lines bypassing the housing enclosure.

According to other aspects, the driver may be an internal combustion engine, and the pumping package may further comprise a fuel tank adjacent to a bottom of the housing enclosure, and one or more collection tanks that capture fluid leaking from the internal combustion engine or the fuel tank.

According to an aspect, there is provided a pumping package, comprising a chassis that carries a housing, and a driver and a fluid pump disposed within the housing, the fluid pump comprising a fluid inlet connection that connects to a fluid source and a fluid outlet connection that connects to a fluid destination. One or more sensors detect one or more operating conditions of one or more of: the driver, the fluid pump, the fluid inlet connection, the fluid source, the fluid outlet connection, and the fluid destination. One or more cameras that observe an area external to the housing and the chassis. A communications module transmits readings from the one or more sensors and images captured by the one or more cameras via a wireless communications link.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a mobile pumping package.

FIG. 2 is a top plan view of a mobile pumping package.

FIG. 3 is a top plan view of a chassis of a mobile pumping package.

FIG. 4 is a side elevation view of a chassis of a mobile pumping package.

FIG. 5 is a side elevation view of a housing.

FIG. 6 is a top plan view of a collection tray.

FIG. 7 is a side elevation view of a self-priming pump.

FIG. 8 is a top plan view of a self-priming pump.

FIG. 9 is a top plan view of a mobile pumping package with cameras.

FIG. 10 is a flow chart for engaging the priming system.

### DETAILED DESCRIPTION OF PREFERRED EMBODIMENTS

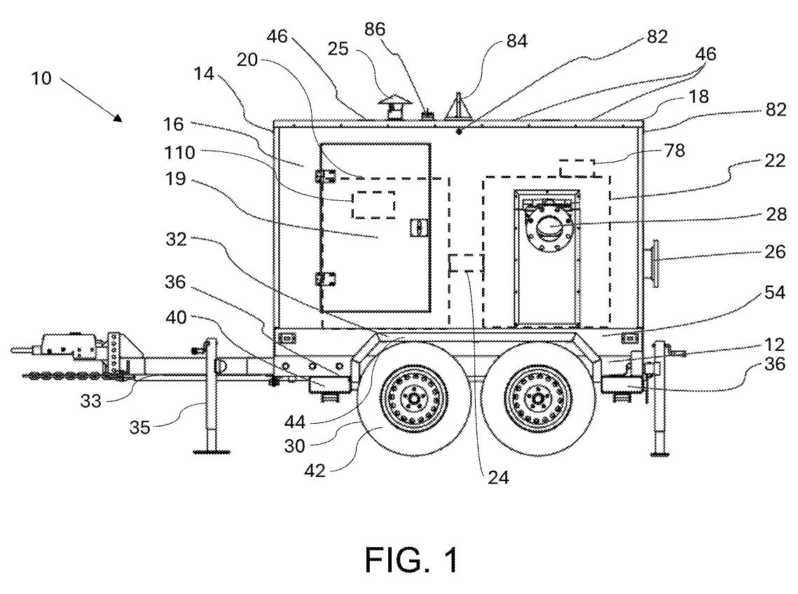

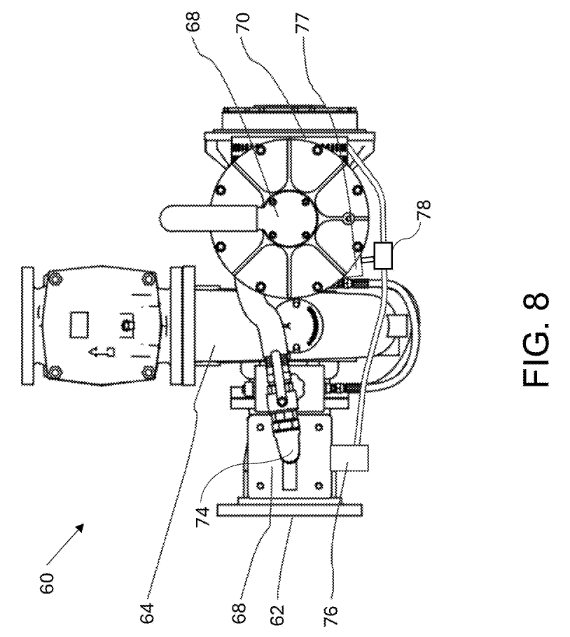

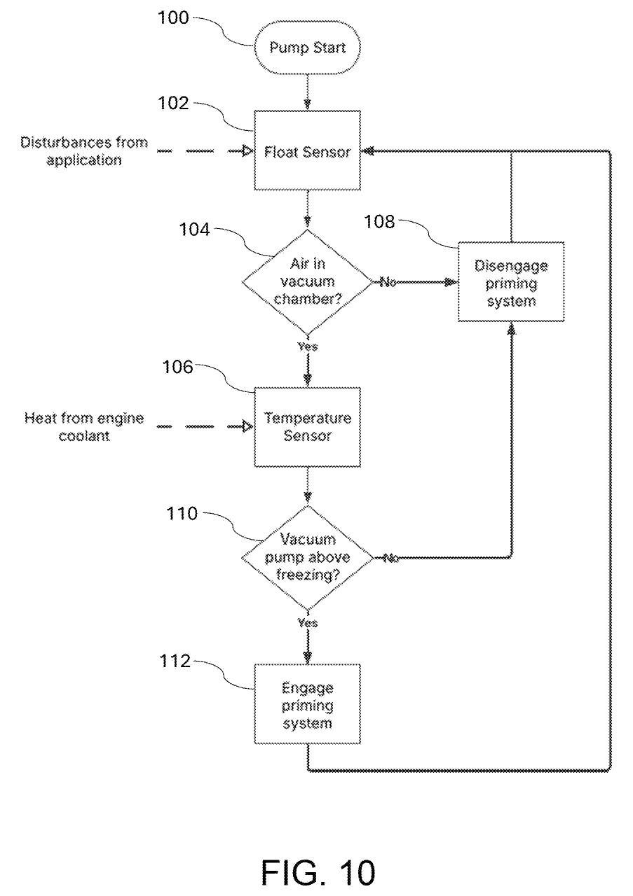

A mobile pumping package, generally identified by reference numeral 10, will now be described with reference to FIGS. 1-10.

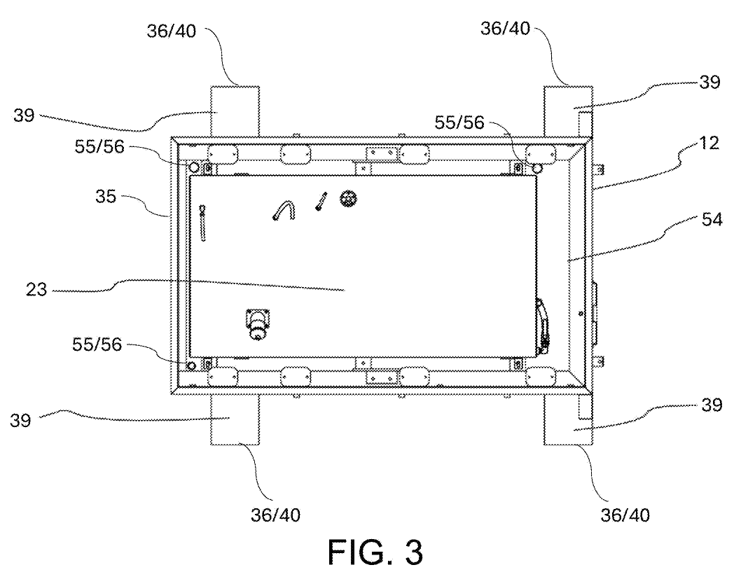

Referring to FIG. 1, mobile pumping package 10 includes a chassis 12 and a housing 14 supported by chassis 12. Housing 14 has sidewalls 16 and a roof panel 18 supported by sidewalls 16. Housing 14 defines an enclosure that may be accessible by an access door 19. Housing 14 encloses a driver 20 and a fluid pump 22 that is driven by driver 20. Driver 20 may be an internal combustion engine, such as a diesel or gasoline engine. If driver 20 is an internal combustion engine, housing 14 may include a fuel tank 23 (shown in FIG. 3) adjacent to the bottom of the enclosure that is used to fuel driver 20 and an exhaust vent 25. Driver 20 may drive fluid pump 22 by way of a drive linkage 24, such as a drive shaft, a drive belt, drive chain, hydraulic fluid lines, etc. In the examples discussed below, fluid pump 22 is a centrifugal pump that is capable of pumping fluid that may include liquids and solids. The type of fluid pump 22 may be selected based on the intended operation, such as the presence and type of solids in the liquid stream.

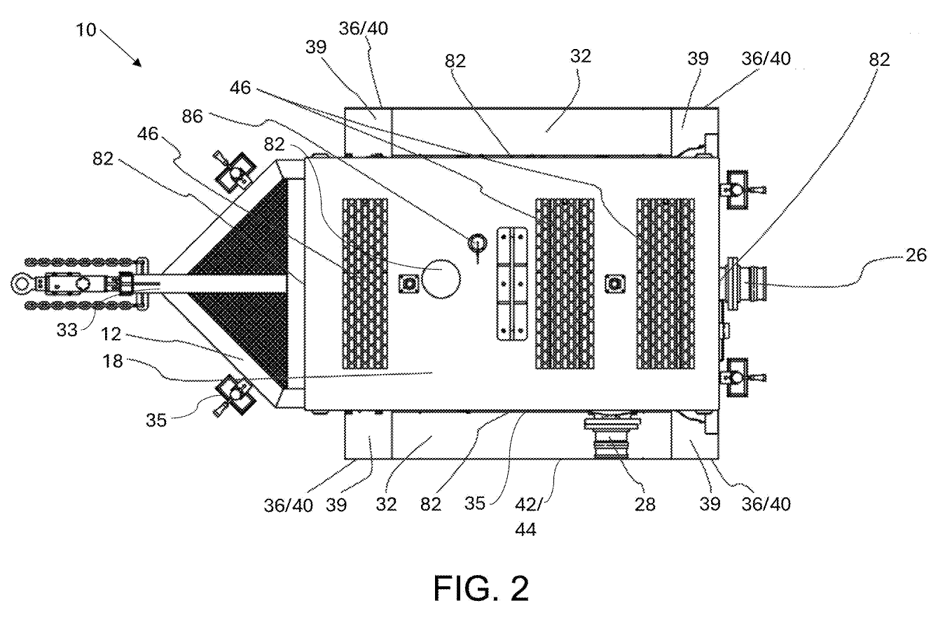

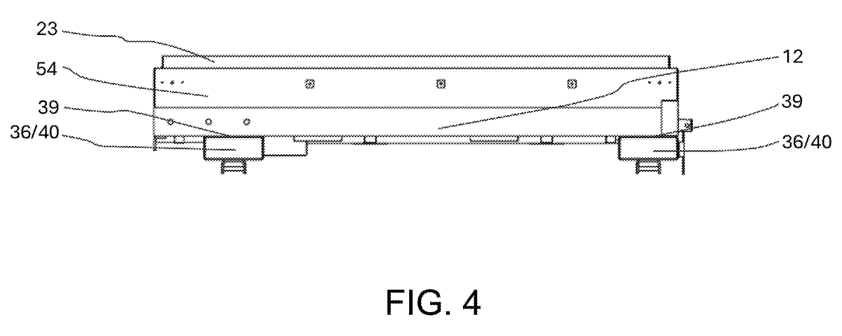

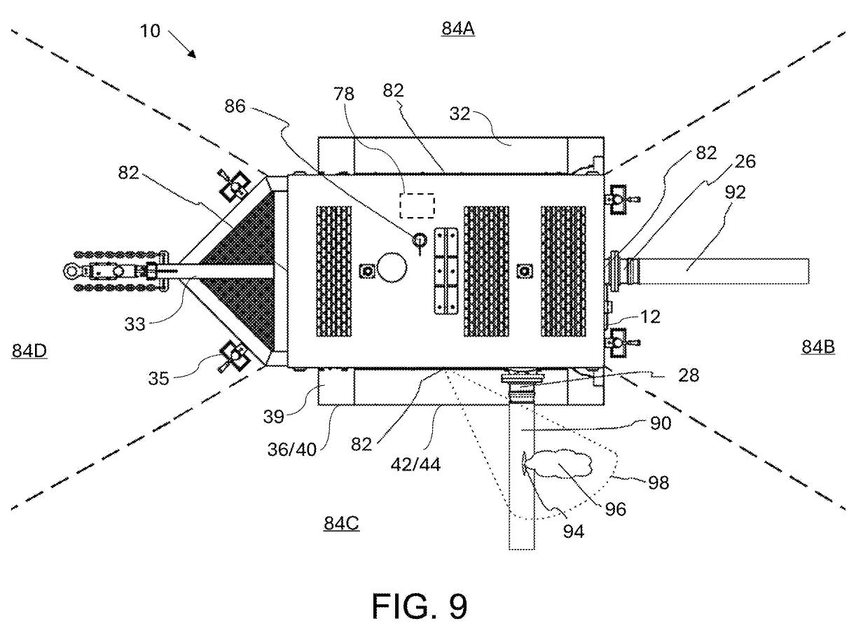

Pump 22 has a fluid inlet connection 26 and a fluid outlet connection 28 from which fluid pump 22 expels fluid. As depicted in FIG. 4, fluid inlet connection 26 and fluid outlet connection 28 are flanges to which fluid lines (not shown) may be connected in order to move fluid from a fluid source to a fluid destination. Connections 26 and 28 may also be a camlock, threaded coupling, or other suitable connection. Fluid inlet connection 26 and outlet connection 28 may be accessible via openings in the sidewalls of housing 14, or, referring to FIG. 2, they may be integrated into housing 14. Pump 22 will be connected to fluid sources using a hose 90 (as shown in FIG. 9) or other conduit connected to connector 26 and may discharge fluid to a fluid destination using a hose 92 (as shown in FIG. 9) or other conduit connected to connector 28. In some circumstances, fluid may be discharged directly from housing 14 without a hose or other conduit.

Referring to FIG. 1, chassis 12 is designed to allow mobile pumping package 10 to be towed. Chassis 12 may also be designed to be a skid mounted unit. As shown, chassis 12 has a set of wheels 30, such as a single or dual axle design, and fenders 32 that cover wheels 30. Chassis 12 may also have a hitch connection 34 carried by a trailer tongue 33 that allows it to be towed. Chassis 12 may have other parts common to trailers, such as stabilizing jacks 35.

### Forklift Channels

In addition to being towable, chassis 12 may be designed to allow mobile pumping package 10 to be moved by a forklift using forklift channels 36. Forklift channels 36 extend perpendicular to wheels 30, or in other words, from the sides of chassis 12.

Referring to FIG. 2, where fenders 32 are included and made from a relatively weak material, such as sheet metal, forklift channels 36 may be designed to protect wheels 30 and/or fenders 32 from damage. As shown, forklift channels 36 extend out past an outer perimeter 38 of chassis 12, such that the tine receiver 40 of forklift channels 36 are at least conterminous with the outer surface 42 of wheels 30, or an outer edge 44 of fender 32. As shown, forklift channels 36 extend out on both sides of chassis 12. By extending outward as shown, the extent to which a forklift may approach chassis 12 is limited. As a result, the forklift is unable to impact or apply a significant force against wheels 30 and/or fenders 32 and therefore limit or avoid damage. In addition to protecting against damage, the portion of at least one forklift channel 36 that extends past outer perimeter 38 may be designed to be used as a step surface 39. In this embodiment, the top surface of forklift channel 36 may be provided with a non-slip surface (not shown).

### Water Drainage

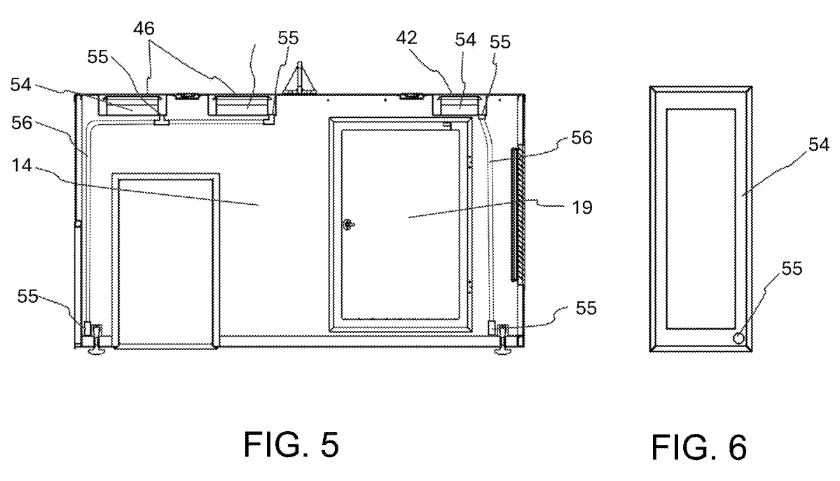

Referring to FIG. 2 , roof panel 18 may have one or more roof vents 46 that permit airflow between the enclosure of housing 14 and the external environment. As vents 46 will be exposed to precipitation, a drainage system is provided that may be integrated with housing 14. Referring to FIG. 5, the drainage system has one or more collection trays 52 at or adjacent to a top end of housing 14 and below roof vents 46 such that collection trays 52 are positioned to capture fluid that enters through roof vents 46. In general, there will be at least one collection tray 52 associated with each roof panel 18. Collection trays 52 drain the collected water via one or more drain ports 55 connected to drain lines 56. Drain lines 56 bypass housing 14 such that the collected water does not enter housing 14. This may be beneficial where driver 20 and/or pump 22 use or produce environmental contaminants, such as the fuel, coolant, hydraulic fluid, oil, lubricants, etc. that may be used by an internal combustion engine and/or a rotary or hydraulic pump. Housing 14 may have a collection tank 54 that is used to capture these environmental contaminants to reduce the risk of pollution. As shown, collection tank 54 may be adjacent to fuel tank 21, such that a leak in fuel tank 21 will be captured by collection tank 54. By providing housing 14 with a drainage system, precipitation may be diverted from collection tank 54. This may reduce the amount of contaminated liquid that needs to be disposed of or treated. It may also reserve a greater proportion of the volume of collection tank 54 for any contaminated or leaking fluids from driver 20 and/or pump 22. Water diverted by drain lines 56 may be deposited onto a ground surface. The water may also be collected in a container, or diverted to a destination, such as a sewer system, a collection pond, etc., depending on the circumstances in which pumping package 10 is used.

In addition to collecting precipitation, providing vents 46 on roof panel 18 rather than the sides encourages sound that is generated by the equipment within housing 14 to be transmitted upward, which may reduce the noise pollution at a work site.

### Self-priming fluid pump

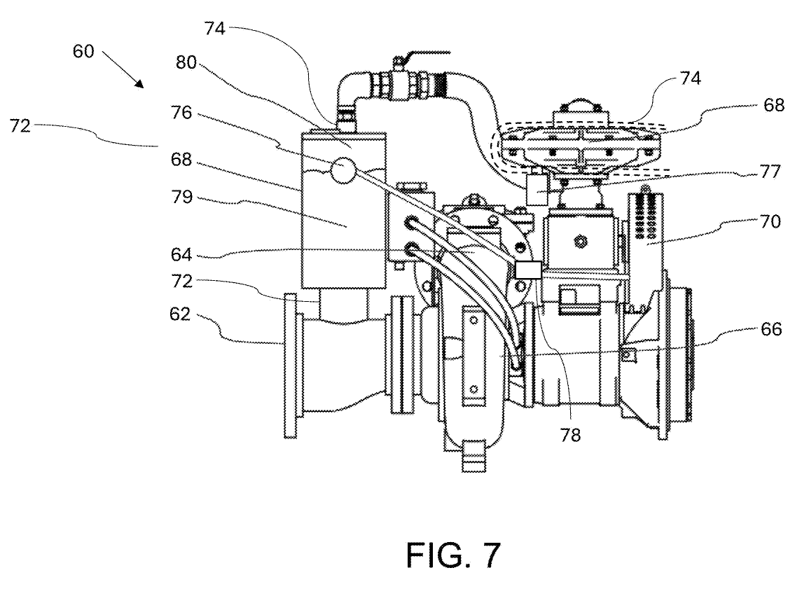

Referring to FIG. 7, there is shown a self-priming fluid pump 60 that may be used in mobile pumping package 10 as fluid pump 22. This is of particular use when using a pump such as a centrifugal pump that requires priming in order to begin pumping fluid, such as a centrifugal pump. Self-priming fluid pump 60 has a fluid intake 62, a fluid discharge 64, and a primary pump 66 disposed to pump fluid between fluid intake 62 and fluid discharge 64. As shown, primary pump 66 is a centrifugal pump that is driven by driver 20 via drive linkage 24 as shown in FIG. 1 and as described above. Self-priming fluid pump 60 also includes a vacuum pump 61 that is attached to a vacuum chamber 68, which is elevated relative to fluid intake 62. As shown, vacuum pump 61 is a diaphragm pump, and is used to prime primary pump 66 by drawing liquid into vacuum chamber 68 from fluid intake 62 in order to ensure fluid pump 22 is primed with fluid at fluid intake 62 at startup. Vacuum pump 61 may also be useful to ensure fluid pump 22 does not lose prime during operation.

As shown, vacuum chamber 68 has a chamber inlet 72 in fluid communication with fluid intake 62 and a vacuum port 74 at (or toward) the top of vacuum chamber 68 in fluid communication with vacuum pump 61. Vacuum pump 61 may be an electric pump that is driven by an electrical power source, or may be driven by mechanical or hydraulic power provided by driver 20. Vacuum pump 61 is selectively driven via a clutch 70. Clutch 70 may be an electric or mechanical clutch, or any selectively engageable device that performs the function of a clutch. Where vacuum pump 61 is an electric pump, clutch 70 may be an electrical switch that interrupts the power supply. Clutch 70 may also be a mechanical clutch that disengages vacuum pump 61, or the pumping element, from the driver.

To avoid operating when water is frozen, vacuum pump 61 may be designed to only run when either the atmospheric temperature, or the temperature of the fluid being pumped if different, is above a minimum temperature. The minimum temperature may be at least 0°C, or higher, such as 5°C. Vacuum pump 61 may have a temperature sensor 77 internal controls, or may be controlled by a controller 78. Where the temperature is below the minimum temperature, clutch 70 may disengage vacuum pump 61. While not shown, vacuum pump 61 may be heated by driver 20. Where driver 20 is an internal combustion engine, vacuum pump 61 may be heated by coolant that circulates through a heat trace line 75 (shown in FIG. 7), or by an exhaust stream that heats the interior of housing 14 (not shown). Vacuum pump 61 may also be heated by an electrical heat trace, which may be powered by an alternator of driver 20 or by an external power source. Controller 78 may be programmed to initiate a heating procedure for vacuum pump 61 where the temperature sensed by temperature sensor 77 is below the minimum temperature.

Vacuum pump 61 is also configured to operate when fluid is below a predetermined level in vacuum chamber 68. During operation, vacuum pump 61 applies vacuum pressure to vacuum chamber 68 via vacuum port 74. The vacuum pressure is applied such that fluid at fluid intake 62 is drawn into vacuum chamber 68 via chamber inlet 72. As depicted, vacuum pump 61 is connected to an air-filled portion 80 of vacuum chamber 68 via vacuum port 74, such that vacuum pump 61 applies a negative gas pressure to vacuum chamber 68. Vacuum port 74 may have a valve (not shown) that closes in the presence of water as a failsafe to protect vacuum pump 61 from water.

As vacuum chamber 68 fills with fluid, a fluid level sensor 76 senses when the level of liquid 79 in vacuum chamber 68 reaches a predetermined level. When the predetermined level is reached, fluid level sensor 76 sends a signal to controller 78 that is programmed to deactivate vacuum pump 61 based on a fluid level sensed by the fluid level sensor. Fluid level sensor 76 may be a float switch or other fluid level sensor that is activated only when the predetermined level is reached. The predetermined fluid level may be selected to be a height that ensures sufficient liquid to prime primary pump 66.

In addition to controlling vacuum pump 61, controller 78 may perform other control functions described herein. As such, controller 78 may be a single unit as shown, or may be multiple separate units that operate independently or in a coordinated manner. If separate units are used, each unit may be programmed to perform one or more functions.

In some examples, fluid level sensor 76 may be a sensor that is able to detect different fluid levels within vacuum chamber 68, and controller 78 may be programmed to activate or deactivate vacuum pump 61 based on either the absolute fluid level in vacuum chamber 68, or by characterizing the manner in which the fluid level in vacuum chamber 68 changes. In addition to deactivating vacuum pump 61 based on the fluid level in vacuum chamber 68 is at or above a minimum fluid level, controller 78 may also be programmed to activate primary pump 66 when the fluid level is below the minimum fluid level.

In operation, vacuum pump 61 may be driven by pump driver 20 or by a separate driver, such as an electric motor (not shown). Where vacuum pump 61 is driven by pump driver 20, pump driver 20 may be configured to drive vacuum pump 61 independently of primary pump 66, i.e., whether vacuum pump 61 is coupled or decoupled from pump driver 20, such that primary pump 66 may run continuously. In one example, drive linkage 24 (shown in FIG. 1) may be a drive shaft that drives pump driver 20, and selectively drives vacuum pump 61 based on a clutch system. The clutch system may, for example, be a pulley wheel on the drive shaft that drives a belt or chain. A known type of clutch may be used to engage and disengage vacuum pump 61.

Using a self-priming system as described may be used to avoid damage and unnecessary wear on vacuum pump 61 and primary pump 66, and may be used to increase the efficiency of primary pump 66 by ensuring a more consistent fluid stream to be pumped. By disengaging vacuum pump 61 when not required, the energy required by pumping package 10 may be reduced.

An example of a control scheme for vacuum pump 61 is shown in FIG. 5 . At step 100, a signal or instruction to start vacuum pump 61 is received. This may be the same control signal that also initiates driver 20 and/or primary pump 66, or may be a separate signal. In step 102, the fluid level in vacuum chamber 68 is measured. In step 104, if it is determined that vacuum chamber 68 does not have air in it, priming pump 61 is disengaged in step 108 and the process returns to step 102 to measure the fluid level in vacuum chamber 68. If, on the other hand, there is insufficient water in vacuum chamber 68, the process moves to step 106 and temperature of priming pump 61 is measured. If the temperature is below a minimum temperature, such as a temperature at which there is a risk of freezing, the priming system is disengaged in step 108 to avoid damage that may result from trying to operate priming pump 61 when ice is present or when the equipment is too cold. This is of particular importance where priming pump 61 is a diaphragm pump, as the part that drives the diaphragm may break if the diaphragm is frozen and unable to move. Where the temperature is too low, priming pump 61 may be heated using heat from driver 20, such as by circulating heated coolant or exhaust to warm priming pump 61. If the temperature is determined to be above the minimum in step 110, the process proceeds to step 112, in which priming pump 61 is engaged. Priming pump 61 continues to operate until there is sufficient liquid in vacuum chamber 68 and the priming operation ends. In this way, priming pump 61 is engaged when there is air in vacuum chamber 68, and when priming pump 61 is above freezing, and proceeds until there is sufficient water in vacuum chamber 68. Temperature sensor 77 may be omitted or bypassed where pumping package 10 is used in climates or environments where there is no risk of reaching freezing temperatures. Where there is a risk of freezing, pump 22 may be heated using heat from driver 20, where driver 20 is an internal combustion engine. Engine 20 may heat pump 22 as it heats the air within housing 14. Engine 20 may generate heat where it is activated in response to the start signal, which also starts the process depicted in FIG. 5. Alternatively, the coolant from engine 20 may be circulated through or around priming pump 61. As priming pump 61 heats, any ice will melt, and the risk of damage will be reduced.

### Sensors

Referring to FIG. 9 mobile pumping package 10 may include one or more sensors that detect one or more operating conditions of mobile pumping package 10. This may include sensors that detect the operating conditions of driver 20, fluid pump 22, the integrity of the connection of fluid inlet 26 and/or fluid discharge 28, and the area surrounding mobile pumping package 10. Examples of sensors include pressure sensors, temperature sensors, cameras, motion detectors, moisture sensors, flow meters, gas detectors, fluid level sensors, and the like. By way of example, the pressure at different locations along the flow path of pumped fluid through mobile pumping package 10 may indicate the efficiency of fluid pump 22, ensure safe operating conditions, or identify potential leaks. Other sensors may include cameras 82 that monitor separate areas, such as four areas identified as areas 84A, 84B, 84C, 84D around mobile pumping package 10. Using known surveillance software, cameras 82 may monitor the area around pumping package 10, such as for unexpected events that may show damage or the potential for damage, detect trespassers, detect leaking fluids, and the like. In the depicted example, a perforation 94 in inlet hose 90 is shown leaking fluid 96. This occurs in area 84C and may be detected in the field of view 98 by the appropriate camera 82. Cameras 82 may also allow a remote user to observe the area around pumping package 10 before activating or deactivating pump 22. In another example, where sensor readings may allow controller 78 to calculate whether pumping package 10 is operating under optimal operating conditions. For example, sensors (not shown) may be used to detect inlet and outlet pressures of pump 22, flow rates, the load on driver 20, etc.. Based on these variables, controller 78 may be used to help calculate whether the pumping package 10 is placed at the “best efficiency point”, whether the efficiency may be improved by reducing the suction head pressure of pump 22, or by reducing the discharge pressure. For example, the appropriate head pressure may be reduced by moving pumping package 10 relative to the water source or destination, or by changing the diameter hoses 90/92. This may be calculated using known formulas and relationships based on the various pressures and flow rates to improve, or optimize where possible, the efficiency of pump 22. Other conditions may also be detected and/or calculated in an analogous manner. A communication device, represented by antenna 86, may be provided that allows for communication between a communication module and an end user, such as by using SCADA, a Wi-Fi network, a cellular network, or other communication system, to transmit sensor readings and images and/or to receive instructions from remote users. By way of example, a user may observe the area around pumping package 10 based on images from camera 82 and then send instructions to initiate pump 22. A user may also send other instructions, such as to regulate pump speed.

Referring to FIG. 1, pumping package 10 may include a user interface 110 that includes a display and/or an input device that allows a user to communicate with controller 78. User interface 110 may be integrated with controller 78, or one portion of controller 78, and user interface 110 may have more than one input devices and /or displays. Controller 78 may be programmed to display messages on user interface, such as instructions or suggestions to operators on how to improve the operation or efficiency of pumping package 10, or reasons why the efficiency may be low, including messages such as “move pumping package closer to water source”, “use larger diameter input/output hose”, and the like. These messages may also be transmitted via antenna 86 to remote users.

In this patent document, the word "comprising" is used in its non-limiting sense to mean that items following the word are included, but items not specifically mentioned are not excluded. A reference to an element by the indefinite article "a" does not exclude the possibility that more than one of the elements is present, unless the context clearly requires that there be one and only one of the elements.

The scope of the following claims should not be limited by the preferred embodiments set forth in the examples above and in the drawings but should be given the broadest interpretation consistent with the description as a whole.

What is claimed is:

1. A self-priming fluid pump, comprising:
a primary pump having a fluid intake and a fluid discharge;
a vacuum chamber that is elevated relative to the fluid intake, the vacuum chamber having a chamber inlet that is in fluid communication with the fluid intake, and a vacuum port;
a vacuum pump that is configured to apply vacuum pressure to the vacuum chamber via the vacuum port such that fluid is drawn into the vacuum chamber via the chamber inlet;
a fluid level sensor in the vacuum chamber; and
a controller that is configured to activate and deactivate the vacuum pump based on a fluid level sensed by the fluid level sensor.

2. The self-priming fluid pump of claim 1, wherein the primary pump is a centrifugal pump and the vacuum pump is a diaphragm pump.

3. The self-priming fluid pump of claim 1, wherein the fluid level sensor is a float switch that senses when the fluid level is at or above a predetermined level.

4. The self-priming fluid pump of claim 1, wherein the controller is configured to deactivate the vacuum pump when the fluid level is at or above a minimum fluid level within the vacuum chamber and activate the vacuum pump when the fluid level is below the minimum fluid level.

5. The self-priming fluid pump of claim 1, wherein the vacuum pump is connected to a pump driver by a clutch, and the controller is configured to activate and deactivate the vacuum pump by engaging and disengaging the clutch.

6. The self-priming fluid pump of claim 1, wherein the vacuum pump is in communication with an air-filled portion of the vacuum chamber via the vacuum port, such that the vacuum pump is configured to apply a negative gas pressure to the vacuum chamber.

7. A method of priming a pump, comprising:
providing:
a primary pump having a fluid intake and a fluid discharge;
a vacuum chamber that is elevated relative to the fluid intake, the vacuum chamber having a chamber inlet that is in fluid communication with the fluid intake, and a vacuum port;
a vacuum pump that is connected to apply vacuum pressure to the vacuum chamber via the vacuum port; and
a fluid level sensor in the vacuum chamber that senses at least a predetermined fluid level;
in response to a start signal, activating the vacuum pump to draw liquid into the vacuum chamber; and
deactivating the vacuum pump when the fluid level in the vacuum chamber is at or above the predetermined fluid level, and activating the vacuum pump when the fluid level is below the predetermined fluid level.

8. The method of claim 7, wherein the primary pump is a centrifugal pump and the vacuum pump is a diaphragm pump.

9. The method of claim 7, wherein the vacuum pump is permitted to be activated after a temperature sensed by a temperature sensor is above a minimum temperature.

10. The method of claim 7, wherein the vacuum pump is connected to a pump driver by a clutch, and activating the vacuum pump comprises engaging the clutch.

11. The method of claim 7, wherein the vacuum pump is in communication with an air-filled portion of the vacuum chamber via the vacuum port, such that the vacuum pump applies a negative gas pressure to the vacuum chamber.

12. A pumping package, comprising:
a driver;
a fluid pump powered by the driver;
a chassis that supports the driver and the fluid pump, the chassis having an outer perimeter and a hitch connection at a towing end of the chassis;
a set of wheels positioned outside the outer perimeter of the chassis, the set of wheels comprising first and second wheels on opposite sides of the chassis and mounted to rotate about an axis of rotation; and
forklift channels mounted to the chassis and adapted to permit the chassis to be lifted by a forklift, the forklift channels extending parallel to the axis of rotation, the forklift channels having a first end defining a tine receiver that extends past the outer perimeter of the chassis such that the tine receiver is at least conterminous with an outer surface of the first wheel.

13. The pumping package of claim 12, further comprising fenders mounted to the chassis, the fenders covering the first and second wheels and being substantially conterminous with the outer surfaces of the first and second wheels.

14. The pumping package of claim 12, wherein the forklift channels are disposed on opposite sides of the axis of rotation.

15. The pumping package of claim 12, wherein the forklift channels have a second end opposite the first end that is conterminous with the outer surface of the second wheel.

16. The pumping package of claim 12, wherein a portion of at least one of the forklift channels that extends past the outer perimeter has a step surface.

17. A pumping package, comprising:
a chassis;
a housing supported by the chassis, the housing comprising sidewalls and a roof panel supported by the sidewalls that define a housing enclosure, the roof panel comprising one or more roof vents that permit airflow between the housing enclosure and an external environment;
a driver and a fluid pump disposed within the housing enclosure; and
a drainage system carried by the chassis, the drainage system comprising:
one or more collection trays at or adjacent to a top end of the housing and below the one or more roof vents, the one or more collection trays being disposed to capture fluid passing through the roof vents; and
one or more drain lines that drain fluid from the one or more collection trays, the one or more drain lines bypassing the housing.

18. The pumping package of claim 17, wherein:
the driver is an internal combustion engine; and
the pumping package further comprises a fuel tank adjacent to a bottom of the housing enclosure;
the pumping package further comprises one or more collection tanks that contaminated fluid from the fuel tank or the driver, the one or more drain lines bypassing the one or more collection tanks.
